(19) United States
(12) Patent Application Publication
(10) Pub. No.: US 2003/0061716 A1
(43) Pub. Date: Apr. 3, 2003

(54) Auxiliary handle of a scissors for scissoring high branches

(76) Inventor: Tsai-Yuan Chen, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/968,894

(22) Filed: Oct. 3, 2001

(51) Int. Cl. B26B 27/00

(52) U.S. Cl. 30/296.1

(57) ABSTRACT

An auxiliary handle of a scissors for scissoring high branches, including a first casing and a second casing which are symmetrical to each other. The first and second casings are pivotally connected with each other at one end to define therebetween a receptacle. An elongated tube of the scissors is passed through the receptacle. A cap member is tightened on the other end of the first and second casings, whereby the first and second casings can tightly clamp the elongated tube to fix the auxiliary handle on the elongated tube.

### BACKGROUND OF THE INVENTION

The present invention is related to an improved auxiliary handle of a scissors for scissoring high branches. The auxiliary handle can be easily detached from the scissors to reduce the volume thereof.

FIG. 6 shows a conventional scissors for scissoring high branches. Such scissors has a hollow tube 71. A trigger section 72 and a cutter section 73 are respectively disposed at two ends of the hollow tube 71. A linking mechanism (not shown) is disposed in the hollow tube 71 for connecting the trigger section 72 and the cutter section 73. A user can pull the trigger section 72 to drive the cutter section 73 for scissoring high branches.

The above scissors is used to cut high branches or crop high fruits and thus the hollow tube 71 has a considerable length. In order to aid a user in holding the scissors, the hollow tube 71 is generally equipped with an auxiliary handle 74. Accordingly, a user can hold the trigger section 72 with one hand and hold the auxiliary handle 74 with the other hand to stably operate the scissors.

However, the auxiliary handle 74 laterally extends from the hollow tube 71 so that the width and volume of the scissors are increased. This leads to inconvenience in storage or transfer of the scissors. Therefore, it is necessary to provide a scissors for scissoring high branches in which the auxiliary handle 74 is detachable to reduce the volume of the scissors.

### SUMMARY OF THE INVENTION

It is therefore a primary object of the present invention to provide an auxiliary handle of a scissors for scissoring high branches. The auxiliary handle can be easily assembled with or detached from the scissors to reduce the volume thereof. The auxiliary handle includes a first casing and a second casing which are pivotally connected with each other at one end. A cap member is tightened on the other end of the first and second casings to lock the same together. When the cap member is untightened and taken off, the first and second casings can be pivotally rotated open. At this time, the auxiliary handle can be easily taken off from the scissors or mounted on the scissors.

It is a further object of the present invention to provide the above auxiliary handle of a scissors for scissoring high branches in which the first casing is formed with a slot. An engaging member is slidably fitted through the slot. One end of the engaging member approximate to the second casing is formed with an engaging hole. The second casing has a projecting engaging section corresponding to the engaging hole. The engaging section can be engaged with the engaging hole to prevent the first and second casings from abruptly bounding open due to the resilient force of the torque spring when taking off the cap member.

The present invention can be best understood through the following description and accompanying drawings wherein:

### BRIEF DESCRIPTION OF THE DRAWINGS

FIG. 1 is a perspective exploded view of the present invention;

FIG. 2 is a perspective view showing the application of the present invention to the scissors for scissoring high branches;

FIG. 3a is a sectional view taken along line III-III of FIG. 2, in which the scissors is not shown;

FIG. 3b is an enlarged view of the engaging member and the engaging section of the second casing;

FIG. 4 shows that the outer diameter of the C-shaped retainer ring is larger than the width of the slot;

FIG. 5a shows that the cap member is taken off, while the engaging member is not moved and the first and second casings are not bounded open;

FIG. 5b shows that the cap member is taken off and the first and second casings pivotally rotate open; and

FIG. 6 shows a conventional scissors for scissoring high branches.

### DETAILED DESCRIPTION OF THE PREFERRED EMBODIMENT

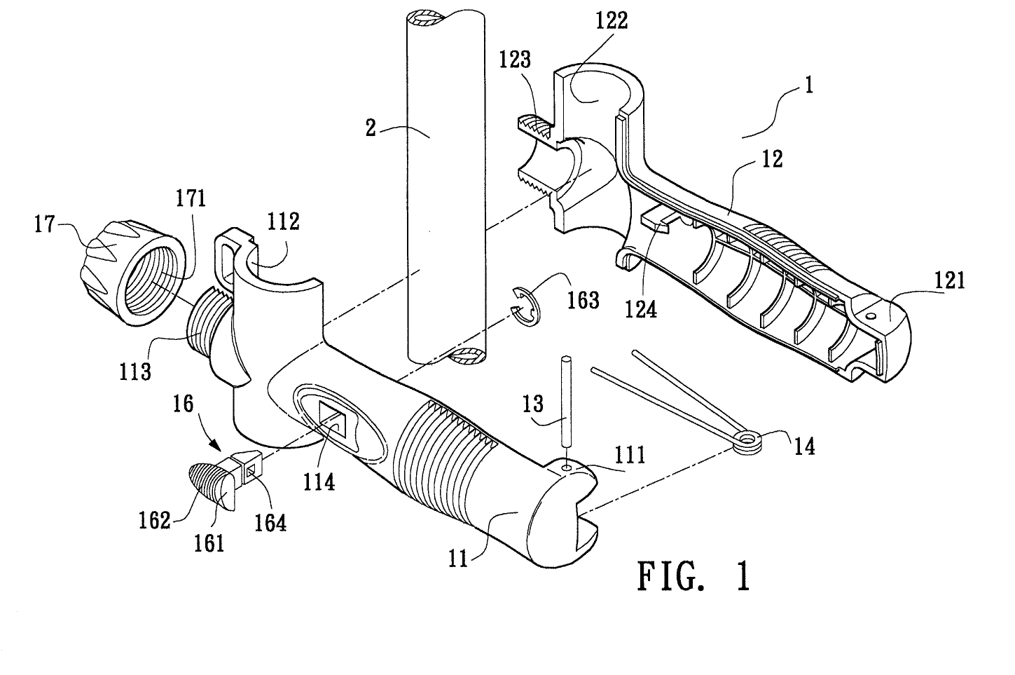

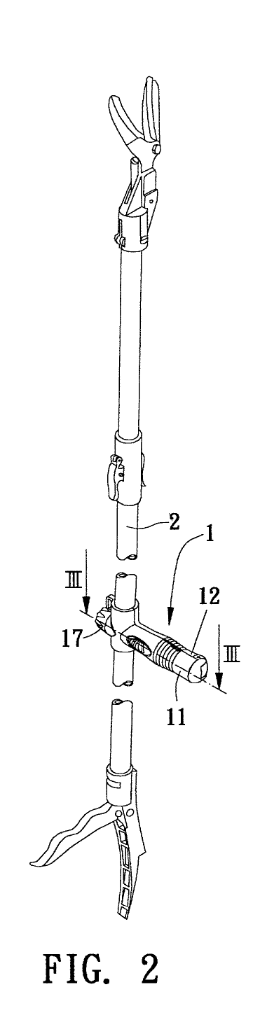

Please refer to FIGS. 1 to 5. The auxiliary handle of a scissors for scissoring high branches according to the present invention includes a first casing 11 and a second casing 12 which are symmetrical to each other. The free ends of the first and second casings 11, 12 are respectively formed with two pivot sections 111, 121. A pin member 13 is passed through the pivot sections to pivotally connect the first and second casings 11, 12. A torque spring 14 is fitted on the pin member 13. Two ends of the torque spring 14 respectively abut against the inner faces of the first and second casings 11, 12. In normal state, the torque spring 14 resiliently makes the first and second casings 11, 12 pivotally rotate in reverse directions into an open state.

The other ends of the first and second casings 11, 12 opposite to the pivot sections 111, 121 are respectively formed with two outer thread sections 113, 123. The inner sides of the first and second casings 11, 12 are respectively formed with two dented sections 112, 122 opposite to each other. The two dented sections 112, 122 together define a receptacle 15 through which an elongated tube 2 is passed.

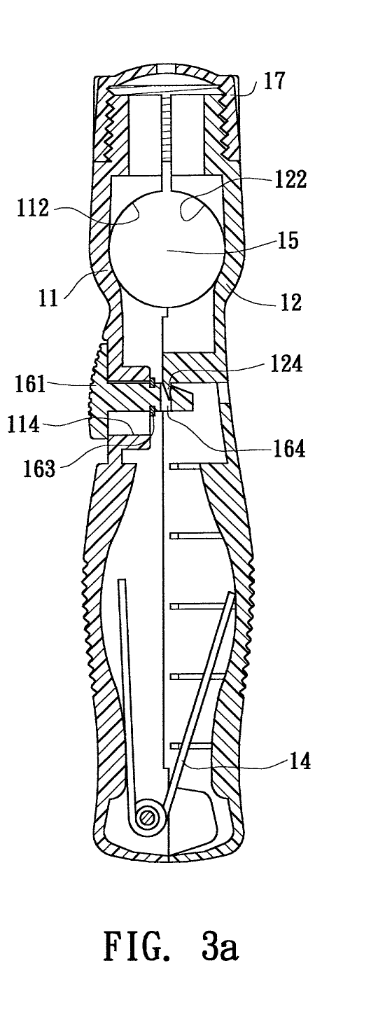

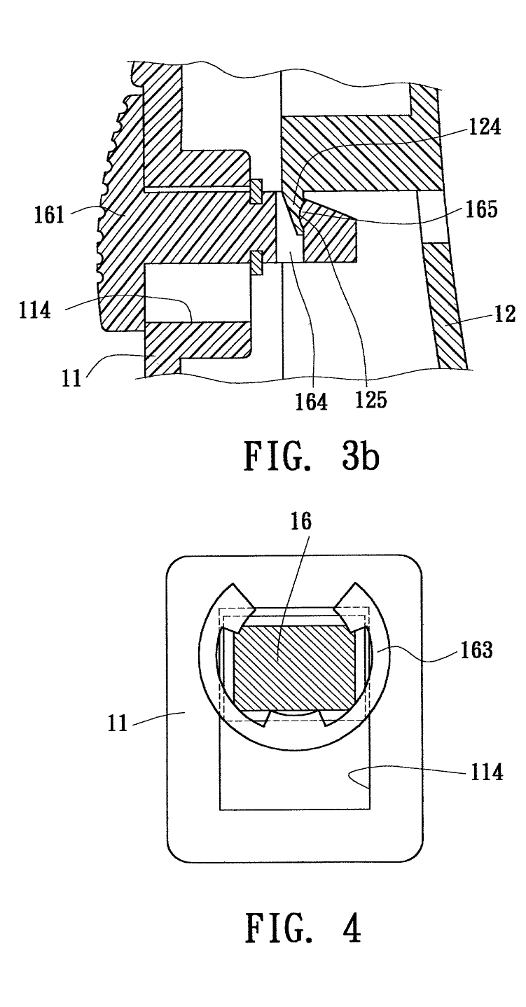

The first casing 11 is formed with a slot 114. An engaging member 16 is slidably fitted through the slot 114 and movable along the length of the slot 114. One end of the engaging member 16 approximate to the slot 114 has a push section 161 positioned on outer side of the first casing and wider than the slot 114. The surface of the push section 161 is formed with slipproof stripes 162 for easy pushing. After the engaging member 16 is passed into the slot 114, a C-shaped retainer ring 163 is fitted on the engaging member 16. The C-shaped retainer ring 163 has an outer diameter larger than the width of the slot 114. In addition, the end of the engaging member 16 approximate to the second casing is formed with an engaging hole 164. An arched engaging block 165 is formed in the engaging hole 164 and projects outward as shown in FIG. 3b. The second casing has a projecting engaging section 124 corresponding to the engaging hole 164 of the engaging member 16. The engaging section 124 has an arched engaging depression 125 corresponding to the engaging block 165.

The auxiliary handle 1 further has a cap member 17 formed with a conic inner thread section 171 corresponding to the outer thread sections 113, 123 of the first and second casings 11, 12. Therefore, the cap member 17 can be screwed on the first and second casings 11, 12.

When installed, the dented section of one of the first and second casings 11, 12 is leant on the elongated tube 2 of the scissors. Then, the other of the first and second casings 11, 12 is rotated to mate the two casings with each other, whereby the two dented sections embrace the elongated tube 2 which passes through the receptacle 15. Then, the push section 161 of the engaging member 16 is pushed to move the engaging member 16, making the engaging section 124 of the second casing inserted into the engaging hole 164 with the engaging block 165 engaged in the engaging depression 125. At this time, the first and second casings 11, 12 are temporarily located without turning open due to the resilient force of the torque spring 14. Then the cap member 17 is screwed and tightened on the outer thread sections 113,123 of the first and second casings 11, 12, whereby the two dented sections tightly clamp the elongated tube 2 of the scissors and the auxiliary handle 1 is fixed.

When detaching the auxiliary handle 1 from the scissors, the cap member 17 is first untightened and taken off. Then the engaging member 16 is pushed in reverse direction to disengage the engaging block 165 from the engaging depression 125. Also, the engaging section 124 is separated from the engaging hole 164. At this time, the torque spring 14 will resiliently make the first and second casings 11, 12 pivotally rotate and separate from each other. Under such circumstance, the auxiliary handle 1 can be conveniently taken off from the scissors.

The inner thread section 171 of the cap member 17 is conic so that when the cap member 17 is gradually screwed onto the outer thread sections 113, 123 of the first and second casings, the two casings will get closer to each other to enhance the clamping force exerted by the two dented sections onto the elongated tube 2. Therefore, the auxiliary handle 1 is more firmly fixed on the elongated tube 2.

In addition, when mounting the auxiliary handle 1 on the scissors, by means of the engaging member 16, the resilient force of the torque spring 14 can be overcome and the first and second casings 11, 12 can be temporarily locked together for more quickly and easily tightening the cap member 17.

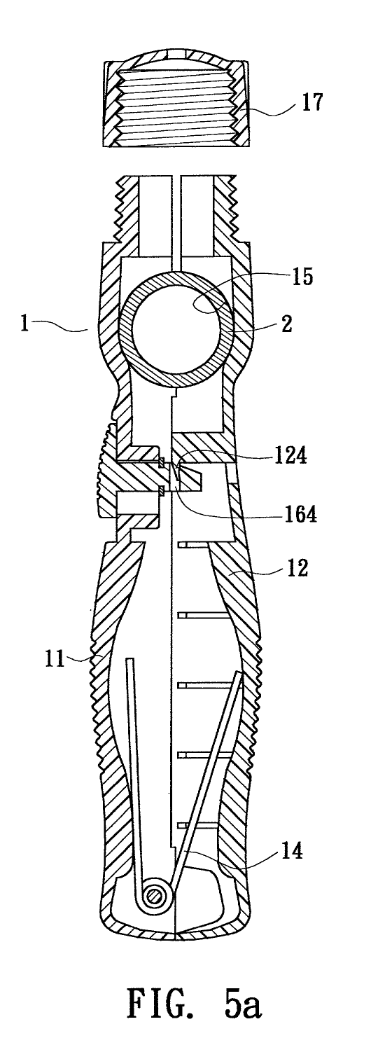

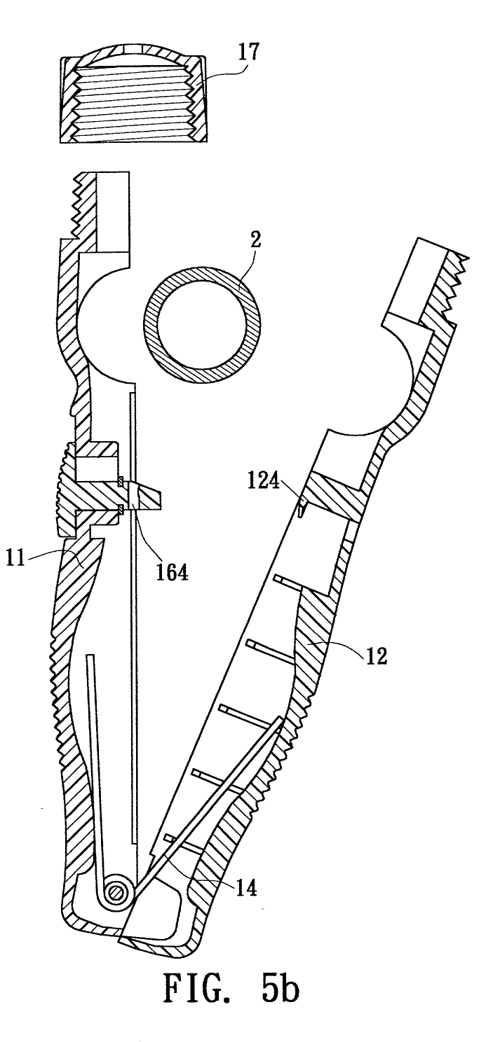

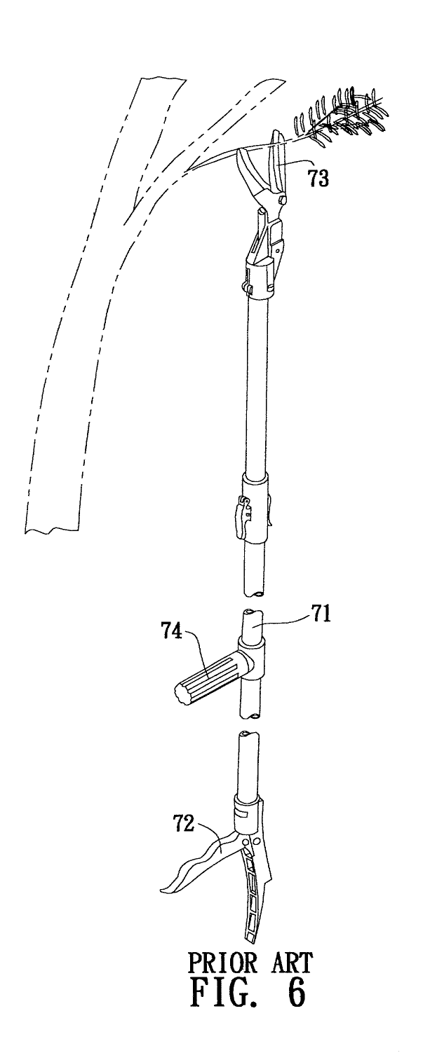

When untightening the cap member 17 to detach the auxiliary handle 1, the engaging hole 164 of the engaging member 16 is still engaged with the engaging section 124 of the second casing as shown in FIG. 5a. Accordingly, the first and second casings 11, 12 are prevented from abruptly bounding open due to the resilient force of the torque spring 14 after the cap member 17 is taken off.

Moreover, as shown in FIGS. 3a and 4, the C-shaped retainer ring 163 of the engaging member 16 has an outer diameter larger than the width of the slot 114. Therefore, the C-shaped retainer ring 163 is stopped by the inner side of the slot 114 to prevent the engaging member 16 rearward dropping out of the first casing. The push section 161 has a width longer than the width of the slot 114 so that the push section 161 is stopped by the outer side of the slot 114 to prevent the engaging member 16 from dropping into the first casing.

The above embodiment is only used to illustrate the present invention, not intended to limit the scope thereof. Many modifications of the above embodiment can be made without departing from the spirit of the present invention.

What is claimed is:

1. An auxiliary handle of a scissors for scissoring high branches, comprising a first casing and a second casing which are symmetrical to each other, free ends of the first and second casings being respectively formed with two pivot sections, a pin member being passed through the pivot sections to pivotally connect the first and second casings, a torque spring being fitted on the pin member, two ends of the torque spring respectively abutting against inner faces of the first and second casings, whereby in normal state, the torque spring resiliently makes the first and second casings pivotally rotate in reverse directions into an open state, the other ends of the first and second casings opposite to the pivot sections being respectively formed with two outer thread sections, the auxiliary handle further comprising a cap member formed with a conic inner thread section corresponding to the outer thread sections, whereby the cap member can be screwed on the outer thread sections of the first and second casings, inner sides of the first and second casings being respectively formed with two dented sections opposite to each other, the two dented sections together defining a receptacle through which an elongated tube is passed, the cap member being tightened on the outer thread sections of the first and second casings, whereby the two dented sections tightly clamp the elongated tube to fix the auxiliary handle on the elongated tube, the first casing being formed with a slot, an engaging member being slidably fitted through the slot, one end of the engaging member approximate to the second casing being formed with an engaging hole, the second casing having a projecting engaging section corresponding to the engaging hole, whereby the engaging section can be engaged with the engaging hole to prevent the first and second casings from directly pivotally rotating open due to the resilient force of the torque spring.

2. The auxiliary handle of a scissors for scissoring high branches as claimed in claim 1, wherein after the engaging member is passed into the slot, a C-shaped retainer ring is fitted on the engaging member, the C-shaped retainer ring having an outer diameter larger than the width of the slot so as to prevent the engaging member from retreating from the slot.

3. The auxiliary handle of a scissors for scissoring high branches as claimed in claim 1, wherein an arched engaging block is formed in the engaging hole of the engaging member and projects outward, the engaging section of the second casing having an arched engaging depression corresponding to the engaging block.
